(19) United States
(12) Patent Application Publication
(10) Pub. No.: US 2018/0189860 A1
(43) Pub. Date: Jul. 5, 2018

(54) ITEM RECOMMENDATION SYSTEM, ITEM RECOMMENDATION METHOD, AND COMPUTER PROGRAM PRODUCT

(71) Applicants: Kabushiki Kaisha Toshiba, Minato-ku (JP); Toshiba Digital Solutions Corporation, Kawasaki-shi (JP)

(72) Inventor: Shinichiro HAMADA, Yokohama (JP)

(73) Assignees: Kabushiki Kaisha Toshiba, Minato-ku (JP); Toshiba Digital Solutions Corporation, Kawasaki-shi (JP)

(21) Appl. No.: 15/909,687

(22) Filed: Mar. 1, 2018

Related U.S. Application Data
(63) Continuation of application No. PCT/JP2016/075712, filed on Sep. 1, 2016.

(30) Foreign Application Priority Data
Sep. 4, 2015 (JP) 2015-174413

(51) Int. Cl. G06Q 30/06; H04L 29/08

(52) U.S. Cl. CPC G06Q 30/0631; H04L 67/306; G06Q 30/0643

(57) ABSTRACT

According to an embodiment, an item recommendation system includes a first recommendation engine that selects, from a group of items, first recommended items predicted to match with preference of a user; a second recommendation engine that selects second recommended items which do not match with the preference of the user but are expected to be of interest to the user; a mixer that mixes the first recommended and second recommended items and forms a group of recommended items; a user interface that presents the group of recommended items in an operable manner to the user; a calculator that calculates the level of interest indicating the degree of user satisfaction with respect to the group of recommended items; and a ratio control unit that, based on the calculated level of interest, varies the mixing ratio of the first recommended items and the second recommend items in the group of recommended items.

### CROSS-REFERENCE TO RELATED APPLICATIONS

This application is a continuation of PCT international application Ser. No. PCT/JP2016/075712 filed on Sep. 1, 2016, which designates the United States, and which claims the benefit of priority from Japanese Patent Application No. 2015-174413, filed on Sep. 4, 2015; the entire contents of which are incorporated herein by reference.

### FIELD

An embodiment described herein relates generally to an item recommendation system, an item recommendation method, and a computer program product.

### BACKGROUND

An item recommendation system is implemented in various service sectors such as the webpage search service, the electronic commerce (EC) service, and the news distribution service. In an item recommendation system, items to be recommended to a user (hereinafter, called “recommendation items”) are selected from a group of a number of different items, and the recommendation items are presented to the user. In a typical item recommendation system, recommendation items that are predicted to match with the preference of a user are selected from a group of items, and the recommended items are presented to the user. For example, a prediction assessment value indicating the degree of match with the preference of the user is calculated for each item included in the group of items, and the items having high prediction assessment values are selected as the recommendation items and are presented to the user.

Meanwhile, from the problem consciousness that, even if there is an item that matches with the preference of a user, it may not be of much worth if known already; there is an attempt to present the recommended items to the user by placing emphasis on serendipity. The concept of serendipity covers novelty, the element of surprise, and unexpectedness. Since it is difficult to perform direct quantitative assessment of serendipity, various substitutive indexes have been proposed. As one of the indexes, there is an attempt to make use of diversity. Herein, diversity implies that the recommended items presented to the user are not similar to each other. In an item recommendation system using such diversity, recommended items across a wide range of fields are presented to the user. If those recommended items include items that have the element of surprise for the user and that are intriguing to the user, then it becomes possible to produce a high degree of user satisfaction.

Regarding the method of presenting recommended items that are predicted to match with the preference of the user, although it is not possible to produce a high degree of user satisfaction as produced in the method of presenting recommended items by placing emphasis on serendipity, it is less likely that recommended items that are not of interest to the user are presented. Hence, that method is characterized by only a small dispersion in (i.e., by being stable regarding) the degree of user satisfaction with respect to the recommendation result. On the other hand, although the method of presenting recommended items by placing emphasis on serendipity sometimes produces a high degree of user satisfaction, it is also likely that only such recommended items which are not of interest to the user are presented. Hence, that method is characterized by a large dispersion in the degree of user satisfaction with respect to the recommendation result. In that regard, a recommendation system has been proposed in which both methods are combined, so that a high degree of user satisfaction can be expectedly produced while achieving stability in the degree of user satisfaction with respect to the recommendation result. For example, a system is known in which new products and items that are not much known to the user are mixed with the list of recommended items matching with the preference of the user.

### BRIEF DESCRIPTION OF THE DRAWINGS

FIG. 1 is a block diagram illustrating an exemplary configuration of an item recommendation system;

FIG. 2 is a diagram illustrating an exemplary data structure of usage history information;

FIG. 3 is a flowchart for explaining an example of the operations performed by a mixer;

FIG. 4 is a diagram illustrating an example of screen display in a user interface (UI) device;

FIG. 5 is a flowchart for explaining an example of the operations performed by an interest level calculator;

FIG. 6 is a diagram illustrating an exemplary data structure of interest level history information stored in an interest level history database (DB);

FIG. 7 is a flowchart for explaining an example of the operations performed by a ratio control unit; and

FIG. 8 is a block diagram that schematically illustrates an exemplary hardware configuration of a server device.

### DETAILED DESCRIPTION

According to an embodiment, an item recommendation system includes a first recommendation engine, a second recommendation engine, a mixer, a user interface, a calculator, and a ratio control unit. The first recommendation engine selects, from a group of items, first recommended items predicted to match with preference of a user. The second recommendation engine selects, from the group of items, second recommended items which do not match with preference of the user but are expected to be of interest to the user. The mixer mixes the first recommended items and the second recommended items, and forms a group of recommended items to be presented to the user. The user interface presents the group of recommended items to the user in an operable manner. Based on a user operation with respect to the group of recommended items, the calculator calculates a level of interest indicating degree of satisfaction of the user with respect to the group of recommended items. The ratio control unit that, based on the level of interest, varies a mixing ratio of the first recommended items and the second recommended items in the group of recommended items formed by the mixer.

An embodiment of an item recommendation system, an item recommendation method, and a computer program product is described below in detail with reference to the accompanying drawings.

The item recommendation system according to the embodiment includes two recommendation engines of different types as recommendation engines for selecting recommended items from a group of a number of different items. One recommendation engine selects recommended items that are predicted to match with the preference of the user, and the other recommendation engine selects recommended items that do not match with the preference of the user but that are expected to be of interest to the user. Since the latter recommendation engine selects recommendation items having the element of surprise for the user, the recommendation engine can be said to select recommended items by placing emphasis on serendipity. In the item recommendation system according to the embodiment, a group of recommended items is formed by mixing the recommended items selected by the two recommendation engines from the group of items, and the group of recommended items is then presented to the user.

In the embodiment, of the two recommendation engines mentioned above, the former recommendation engine is called a “first recommendation engine”, and the latter recommendation engine is called a “second recommendation engine”. Moreover, the recommended items selected by the first recommendation engines from the group of items are called “first recommendation items”, and the recommended items selected by the second recommendation engines from the group of items are called “second recommendation items”. Furthermore, an upper-level module that includes the first recommendation engine; the second recommendation engine; and a mixer for forming a group of recommended items by combining the first recommended items and the second recommended items is called a “mixer-type recommendation engine”.

Moreover, the item recommendation system according to the embodiment has a mechanism for evaluating the degree of user satisfaction with respect to the group of recommended items presented to a user; and, according to the degree of user satisfaction, varies the mixing ratio of the first recommended items and the second recommended items in the group of recommended items. More particularly, for example, with respect to the groups of recommended items presented to the user in recent instances, in case the degree of user satisfaction is successively low, then the mixing ratio of the first recommended items and the second recommended items is varied in such a way that the percentage of the first recommended items, which enable achieving a stable degree of user satisfaction despite being insipid, is increased as compared to the percentage of the first recommended items in the groups of recommended items presented till then. As a result, in a situation in which the risk of user defection is high, the risk of user defection can be lowered by preventing successive presentation of groups of recommended items that are disappointing to the user.

Meanwhile, the item recommendation system according to the embodiment is applicable to various service sectors. For example, the item recommendation system according to the embodiment can be effectively implemented in following service sectors, for example: the webpage search service; the Internet advertising service; the electronic commerce (EC) service (retail stores and travel agencies); the news delivery service (email newsletters, portal sites, and news applications for smartphones); the contents delivery service (movies, music, and books); and the information service (smartphone applications for town information or facilities information, digital signage, and car navigation).

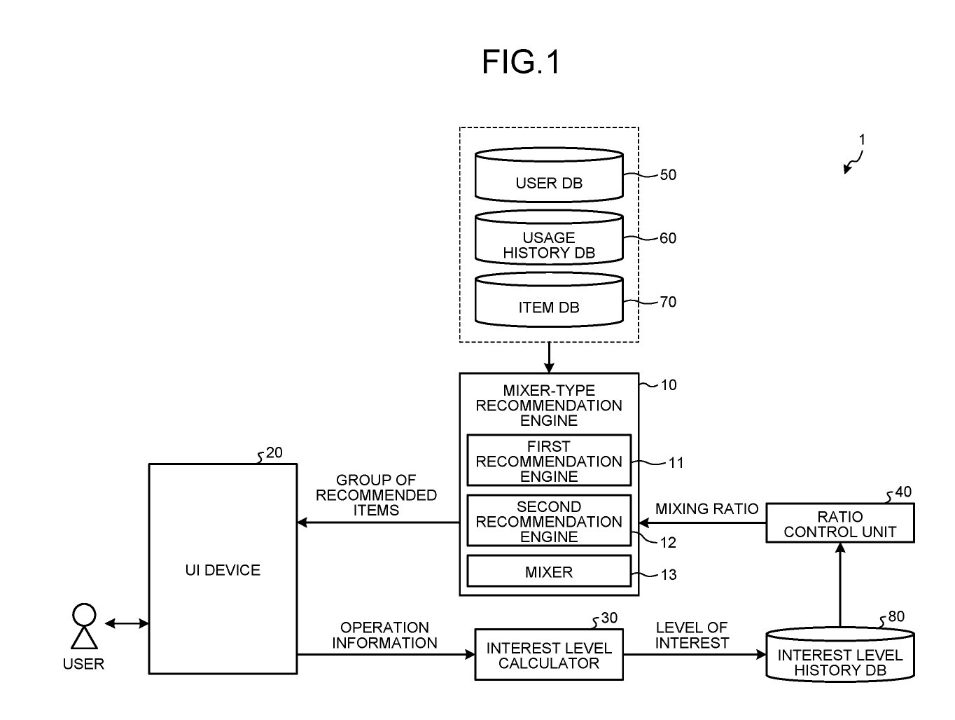

FIG. 1 is a block diagram illustrating an exemplary configuration of an item recommendation system 1 according to the embodiment. As illustrated in FIG. 1, the item recommendation system 1 includes a mixer-type recommendation engine 10, a user interface (UI) device 20, an interest level calculator 30 (a calculator), and a ratio control unit 40.

The mixer-type recommendation engine 10 selects, based on user information stored in a user database (DB) 50 and usage history information stored in a usage history DB 60, recommended items from a group of a number of different items included in an item DB 70; and outputs the group of recommended items.

In the user DB 50, a variety of information related to all registered users, who are registered as users of the item recommendation system 1, (i.e., user information) is stored in a corresponding manner to user IDs assigned to the registered users. The variety of information related to the registered users not only contains the basic information of each registered user such as the name, the age, and the gender; but also contains information such as the profession, the favorite sport, and the favorite music genre useful in determining the preference of that registered user. Such information can be retrieved, for example, from the user DB 50 using the user ID, which is input by a registered user when logging in to the item recommendation system 1, as the search key (or using input information, such as the account managed in a corresponding manner to the user ID, as the search key).

In the usage history DB 60, information related to the items which have been of interest to each registered user from among the items in the groups of recommended items presented in the past, that is, information indicating the recommended items accepted and used in the past by each registered user (i.e., usage history information) is stored in a corresponding manner to the user ID of that registered user. Such information can be retrieved from the usage history DB 60 using, for example, the user ID, which is input by a registered user when logging in to the item recommendation system 1, as the search key (or using input information, such as the account managed in a corresponding manner to the user ID, as the search key).

The item DB 70 stores therein a group of a number of different items. The group of items stored in the item DB 70 is different according to the type of the service for which the item recommendation system 1 is implemented. For example, when the item recommendation system 1 is implemented for the news delivery service, the items included in the group of items represent a number of different news articles.

Meanwhile, the user DB 50, the usage history DB 60, and the item DB 70 are stored in an arbitrary memory device that is accessible to the mixer-type recommendation engine 10.

As illustrated in FIG. 1, the mixer-type recommendation engine 10 includes a first recommendation engine 11, a second recommendation engine 12, and a mixer 13.

The first recommendation engine 11 selects, from the group of items stored in the item DB 70, first recommended items that are predicted to match with the preference of the user to whom a group of recommended items is to be presented (hereinafter, called a “target user”). As methods implemented in the first recommendation engine 11, various methods have been proposed. Herein, it is assumed that the collaborative filtering method using matrix decomposition as disclosed in Non-patent Literature (J. Canny. Collaborative filtering with privacy via factor analysis. In Proc. Of the 25th Annual ACM SIGIR Conf. on Research and Development in Information Retrieval, pp. 238-245, 2002) is implemented as the fundamental method. In that method, the prediction assessment value for the target user is calculated with respect to each unevaluated item (i.e., an item that has not been presented to the target user in the past). The prediction assessment value indicates the degree of match between the item and the preference of the user. Then, the first recommendation engine 11 selects, from the group of recommended items stored in the item DB 70, the items having high prediction assessment values as the first recommended items. For example, the items included in the group of items are sorted in descending order of the prediction assessment values, and the items are sequentially selected from the top as the first recommended items.

The second recommendation engine 12 selects, from the group of items stored in the item DB 70, second recommended items that do not match with the preference of the target user but that are expected to be of interest to the target user. Herein, whether or not an item does not match with the preference of the user but is expected to be of interest to the target user is determined using a serendipity index value. The serendipity index value is calculated using a product of a first value indicating the probability at which the target user takes interest in an item and a second value indicating the degree of deviation of the item from the preference of the target user. More preferably, the serendipity index value is calculated using the linear sum of the product of the first value and the second value with a third value indicating the probability at which any unspecified user takes interest.

In Equation (1) is given an exemplary calculating formula for calculating the serendipity index value. In Equation (1), Score_s represents the serendipity index value; Score_p represents the prediction assessment value (assumed to be in the range of [0, 1]) calculated by the first recommendation engine 11; Interest represents the probability at which any unspecified user takes interest; and α represents the weight coefficient (a constant number equal to or greater than zero and equal to or smaller than one) used in weighting the first term and the second term on the right-hand side of Equation (1).

Score_s=α×(Score_p×(1−Score_p))+(1−α)×Interest (1)

Herein, the prediction assessment value Score_p, which is calculated by the first recommendation engine 11, can be treated as the value indicating the probability at which the target user takes interest. Hence, in Equation (1), the prediction assessment value Score_p is used as the first value mentioned above. Moreover, the value obtained by subtracting the prediction assessment value Score_p from 1 can be said to indicate the degree of deviation from the preference of the target user. Hence, in Equation (1), the value “1−Score_p” that represents the value obtained by subtracting the prediction assessment value Score_p from 1 is used as the second value mentioned above. However, Equation (1) given above is only an exemplary calculating formula used in calculating the serendipity index value. That is, some other value other than Score_p can be alternatively used as the first value indicating the probability of the target user taking interest, and some other value other than “1−Score_p” can be alternatively used as the second value indicating the degree of deviation from the preference of the target user.

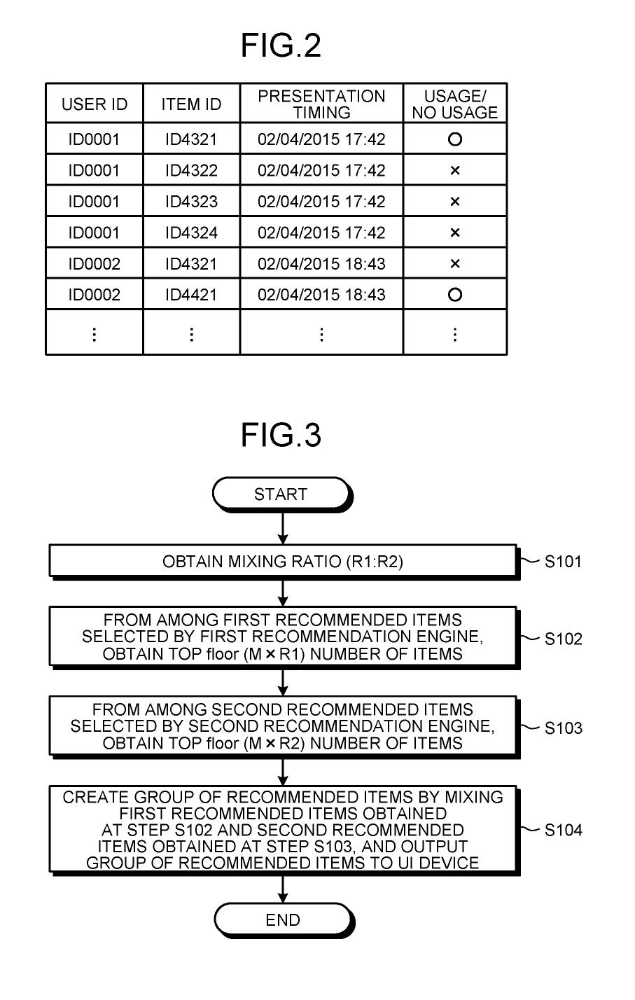

Regarding the second term Interest that is on the right-hand side in Equation (1) and that represents the probability at which any unspecified user takes interest, the calculation can be done using, for example, the usage history information stored in the usage history DB 60. In that case, in the usage history DB 60, the usage history information is stored with a data structure illustrated in FIG. 2, for example. That is, the usage history information has a data structure in which, regarding each recommended item presented to any unspecified user in the past, information such as the item ID, the presentation timing, and usage/no usage information about whether or not that recommended item was used is held in a corresponding manner to the user ID of the user who received the presentation of that recommended item. In the example illustrated in FIG. 2, it can be understood that the item having an item ID “ID4321” was used by the user having a user ID “ID0001” but was not used by the user having a user ID “ID0002”. Hence, the value Interest indicating the probability at which any unspecified user takes interest in the item having item ID “ID4321” can be calculated as ½=0.5. Meanwhile, the data structure of the usage history information illustrated in FIG. 2 is only exemplary, and is not limited to that example. Moreover, the value Interest indicating the probability at which any unspecified user takes interest can be calculated based on some other information other than the usage history information stored in the usage history DB 60.

In Equation (1), the second term on the right-hand side is optional and not mandatory. That is, the serendipity index value with respect to an item can be calculated without taking into account the probability at which any unspecified user takes interest in that item. In that case, the calculating formula for calculating the serendipity index value Score s is simplified as given below in Equation (2).

Score_s=Score_p×(1−Score_p) (2)

The second recommendation engine 12 selects, as the second recommended items, items having high serendipity index values, which are calculated in the manner explained above, from the group of items stored in the item DB 70. For example, the items included in the group of items are sorted in descending order of the serendipity index values, and the items are sequentially selected from the top as the second recommended items.

The mixer 13 forms a group of recommended items by mixing the first recommended items, which are selected by the first recommendation engine 11, and the second recommendation items, which are selected by the second recommendation engine 12; and outputs the group of recommended items to the UI device 20. In the group of recommended items formed by the mixer 13, the mixing ratio of the first recommended items and the second recommended items is controlled by the ratio control unit 40.

In the embodiment, a method is implemented in which the first recommended items and the second recommended items are mixed based simply on the number of items. FIG. 3 is a flowchart for explaining an example of the operations performed by the mixer 13. Herein, the mixer 13 performs operations at Steps S101 to S104 as explained below to form a group of recommended items, and outputs it to the UI device 20. Herein, M represents the total number of recommended items included in the group of recommended items.

Step S101: The mixer 13 obtains a mixing ratio (R1:R2) that is calculated by the ratio control unit 40 (described later). When R1 represents the percentage of the first recommended items included in the group of recommended items; R2 represents the percentage of the second recommended items included in the group of recommended items, and R1+R2=1, 0≤R1≤1, and 0≤R2≤1 holds true. In the case in which the mixing ratio (R1:R2) is not calculated by the ratio control unit 40 such as at the time of initial presentation, a predetermined mixing ratio (R1:R2) can be set as the initial value.

Step S102: From among the first recommended items that are selected by the first recommendation engine 11 from the group of items stored in the item DB 70, the mixer 13 obtains the top floor(M×R1) number of items. Herein, floor represents a function for rounding down the decimal places.

Step S103: From among the second recommended items that are selected by the second recommendation engine 12 from the group of items stored in the item DB 70, the mixer 13 obtains the top floor(M×R2) number of items.

Step S104: The mixer 13 mixes the first recommended items, which are obtained at Step S102, and the second recommended items, which are obtained at Step S103, to form a group of recommended items and outputs it to the UI device 20.

A group of recommended items represents a set of recommended items presented at a predetermined presentation unit. Herein, the presentation unit either can be the number of items to be displayed in a single screen (page) of the UI device 20, or can be a predetermined number of items such as 10 items, 50 items, of 100 items. Alternatively, within a single session starting from the login to the item recommendation system 1 by the target user till the logout, the number of items presented to the target user can be treated as the presentation unit. In the embodiment, for each presentation unit, the interest level calculator 30 calculates the level of interest indicating the degree of user satisfaction; the ratio control unit 40 calculates the mixing ratio (R1:R2); and the mixer 13 forms a group of recommended items.

The UI device 20 is a user interface that presents the group of recommended items, which is output by the mixer 13 of the mixer-type recommendation engine 10, to the target user in an operable manner. For example, the UI device 20 displays the group of recommended items input thereto on a screen; as well as receives, as the user feedback, an operation performed by the target user with respect to the group of recommended items displayed on the screen (for example, opening a recommended item that seems interesting). Then, the UI device 20 sends operation information, which is received as the user feedback, to the interest level calculator 30.

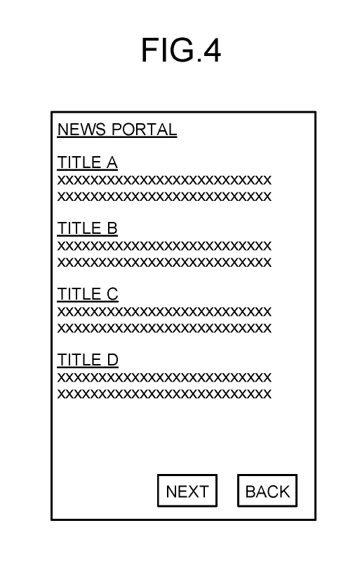

FIG. 4 is a diagram illustrating an example of screen display in the UI device 20, and an example of a news portal site is illustrated therein. In the example of screen display as illustrated in FIG. 4, regarding each news article representing a recommended item included in the group of recommended items, the title and the abstract is written. When a title is clicked, the details of the corresponding news article either pop up on the same screen or are displayed as a separate screen. When a “next” button provided in the screen is clicked, the screen is updated, and news articles representing the lower-ranked recommended items than the currently-displayed recommended items are displayed in an identical manner. When a “back” button provided in the screen is clicked, the previous screen is again displayed.

When the screen display as illustrated in FIG. 4 is performed, the UI device 20 receives, as the user feedback, a user operation of clicking the title of a news article; and, for example, sends information indicating a click on the title of the concerned news article and information such as the item ID and the presentation timing of the news article as operation information to the interest level calculator 30.

Based on the operation information received from the UI device 20, the interest level calculator 30 calculates the level of interest indicating the degree of user satisfaction with respect to the group of recommended items presented to the user by the UI device 20; and stores the calculated level of interest in an interest level history DB 80. In the embodiment, it is assumed that the degree of user satisfaction with respect to a group of recommended items is expressed using the level of interest representing the percentage of the recommended items that were of interest to the target user from among all recommended items included in the group of recommended items. Moreover, it is assumed that whether or not the target user took interest in a recommended item is determined according to whether or not an operation of opening the recommended item (in the example illustrated in FIG. 4, an operation of clicking the title of a news article) is performed. Meanwhile, in the case of a contents delivery service website, if the reproduction period of particular contents, such as a music piece or a movie, presented as a recommended item is equal to or shorter than a certain period of time, it is determined that the target user was not interested in those contents. Thus, the determination criterion regarding the presence or absence of interest can be set according to the application. Based on the operation information received from the UI device 20, the interest level calculator 30 calculates, for each presentation unit explained earlier, the level of interest representing the percentage of the recommended items that were of interest to the target user from among all recommended items included in the group of recommended items; and stores the calculated level of interest in the interest level history DB 80.

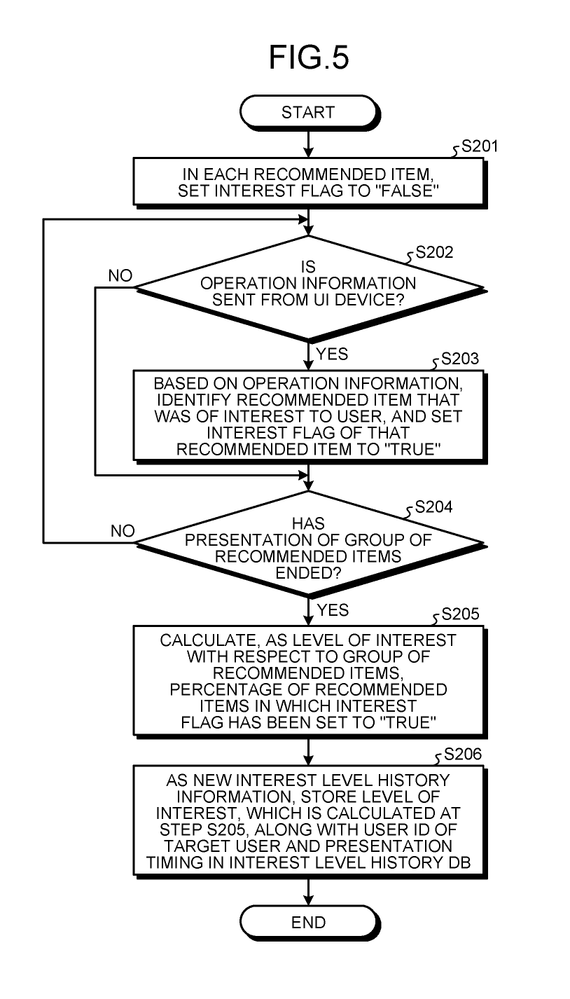

FIG. 5 is a flowchart for explaining an example of the operations performed by the interest level calculator 30. Herein, the interest level calculator 30 performs operations at Steps S201 to S206 as explained below to calculate the level of interest with respect to the group of recommended items presented to the target user by the UI device 20 and to store the level of interest in the interest level history DB 80.

Step S201: The interest level calculator 30 sets an interest flag with respect to each recommended item included in the group of recommended items, and sets “false” as the initial value of each interest flag.

Step S202: The interest level calculator 30 determines whether or not operation information has been received from the UI device 20. If operation information has been received from the UI device 20, then the system control proceeds to Step S203. However, if operation information has not been received from the UI device 20, then the system process proceeds to Step S204.

Step S203: Based on the operation information received from the UI device 20, the interest level calculator 30 identifies the recommended item, from among the recommended items included in the group of recommended items, that was of interest to the target user (in the example illustrated in FIG. 4, the news article whose title was clicked); and sets the interest flag of that recommended item to “true”.

Step S204: The interest level calculator 30 determines whether or not the presentation of the group of recommended items has ended. If the presentation of the group of recommended items has ended, then the system control proceeds to Step S205. However, if the presentation of the group of recommended items has not ended, then the system control returns to Step S202 and the subsequent operations are performed again. Herein, regarding whether or not the presentation of the group of recommended items has ended, the determination criterion is assumed to be different depending on the presentation unit. For example, if the number of items to be displayed in a single screen (page) of the UI device 20 represents the presentation unit, when there is a change in the screen display of the UI device 20, it is determined that the presentation of the group of recommended items has ended. Alternatively, if a predetermined number of items represents the presentation unit, when the number of recommended items presented to the target user reaches the predetermined number of items, it is determined that the presentation of the group of recommended items has ended. Still alternatively, if the number of items presented to the target user in a single session represents the presentation unit, when the target users logs out of the item recommendation system 1 and ends the session, it is determined that the presentation of the group of recommended items has ended.

Step S205: The interest level calculator 30 calculates, as the level of interest with respect to the group of recommended items, the percentage of recommended items for which the interest flag has been set to “true”.

Step S206: The interest level calculator 30 newly adds a record in the interest level history DB 80 and stores the level of interest, which is calculated at Step S205, along with the user ID of the target user and the presentation timing as new interest level history information in the interest level history DB 80.

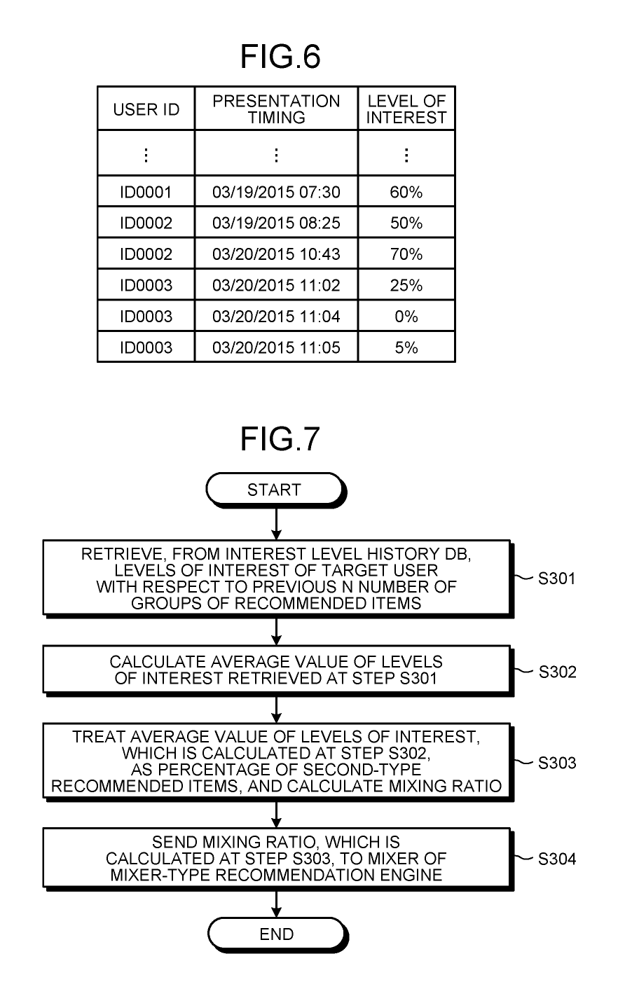

FIG. 6 is a diagram illustrating an exemplary data structure of the interest level history information stored in the interest level history DB 80. For example, as illustrated in FIG. 6, in the interest level history information stored in the interest level history DB 80, the presentation timing of presenting the group of recommended items and the level of interest with respect to the group of recommended items is held in a corresponding manner to the user ID of the target user. Every time the interest level calculator 30 calculates the level of interest with respect to the group of recommended items presented for the presentation unit, a record is newly added to the interest level history information stored in the interest level history DB 80. Meanwhile, the interest level history DB 80 is held in an arbitrary memory device that is accessible to the interest level calculator 30 and the ratio control unit 40.

Based on the level of interest of the target user with respect to the group of recommended items as calculated by the interest level calculator 30, the ratio control unit 40 varies the mixing ratio of the first recommended items and the second recommended items in the group of recommended items formed by the mixer 13 of the mixer-type recommendation engine 10. More particularly, the ratio control unit 40 varies the mixing ratio of the first recommended items and the second recommended items in the group of recommended items formed by the mixer 13 in such a way that, lower the level of interest of the target user with respect to the group of recommended items presented most recently, the higher becomes the percentage of the first recommended items in the group of recommended items to be presented next. As a result, it becomes possible to avoid successive presentation of groups of recommended items having a low degree of user satisfaction, and thus to lower the risk of user defection.

In order to be able to vary the mixing ratio of the first recommended items and the second recommended items in the group of recommended items, the ratio control unit 40 calculates, for each presentation unit, the mixing ratio (R1:R2) of the first recommended items and the second recommended items; and sends the calculated mixing ratio (R1:R2) to the mixer 13 of the mixer-type recommendation engine 10. It is possible to think various methods for calculating the mixing ratio (R1:R2). Herein, for the purpose of illustration, a calculating formula is used in which the average value of the levels of interest with respect to the groups of recommended items in the previous N presentations to the target user is calculated as the percentage R2 of the second recommended items included in the group of recommended items. That is, the ratio control unit 40 obtains, from the interest level history DB 80, the levels of interest of the target user with respect to the groups of recommended items in the previous N presentations; and calculates the mixing ratio (R1:R2) by treating the average value of the levels of interest as the percentage R2 of the second recommended items and by treating 1-R2 as the percentage R1 of the first recommended items.

FIG. 7 is a flowchart for explaining an example of the operations performed by the ratio control unit 40. For each presentation unit, the ratio control unit 40 performs operations from Steps S301 to S304 explained below, and varies the mixing ratio of the first recommended items and the second recommended items in the group of recommended items formed by the mixer 13 of the mixer-type recommendation engine 10.

Step S301: The ratio control unit 40 retrieves, from the interest level history DB 80, the levels of interest of the target user with respect to the groups of recommended items in the previous N presentations. When N is equal to three and assuming that the target user has the user ID “ID0003” in the example illustrated in FIG. 6, the retrieved levels of interest are 5%, 0%, and 25%.

Step S302: The ratio control unit 40 calculates the average value of the levels of interest retrieved at Step S301. In this example, the average value of the levels of interest is (5%+0%+25%)/3=10%.

Step S303: The ratio control unit 40 treats the average value of the levels of interest, which is calculated at Step S302, as the percentage R2 of the second recommended items included in the group of recommended items; and calculates the mixing ratio (R1:R2). In this example, the mixing ratio (R1:R2) becomes 0.9:0.1.

Step S304: The ratio control unit 40 sends the mixing ratio (R1:R2), which is calculated at Step S303, to the mixer 13 of the mixer-type recommendation engine 10. Based on the mixing ratio (R1:R2) received from the ratio control unit 40, the mixer 13 of the mixer-type recommendation engine 10 forms a group of recommended items by mixing the first recommended items, which are selected by the first recommendation engine 11, and the second recommended items, which are selected by the second recommendation engine 12.

As described above in detail with reference to specific examples, in the item recommendation system 1 according to the embodiment, a group of recommended items is presented that includes second recommended items which have the element of surprise for the target user and first recommended items which enable achieving a stable degree of user satisfaction despite being insipid. Hence, a group of recommended items that can be expected to enable achieving a stable and high degree of user satisfaction can be presented to the target user. Moreover, the level of interest indicating the degree of user satisfaction with respect to the group of recommended items is calculated and, the mixing ratio of the first recommended items and the second recommended items in the group of recommend items is varied based on the calculated level of interest. As a result, it becomes possible to avoid successive presentation of groups of recommended items having a low degree of user satisfaction, and thus to lower the risk of user defection. In this way, in the item recommendation system 1 according to the embodiment, groups of recommend items that can be expected to enable achieving a stable and high degree of user satisfaction while lowering the risk of user defection can be presented to the target user.

Meanwhile, as an example, the item recommendation system 1 according to the embodiment can be implemented as a server-client system. In that case, the functions of the UI device 20 are implemented in client terminals operated by users; and the functions of the mixer-type recommendation engine 10 (the first recommendation engine 11, the second recommendation engine 12, and the mixer 13), the interest level calculator 30, and the ratio control unit 40 are implemented in a server device that communicates with and provides services to the client terminals.

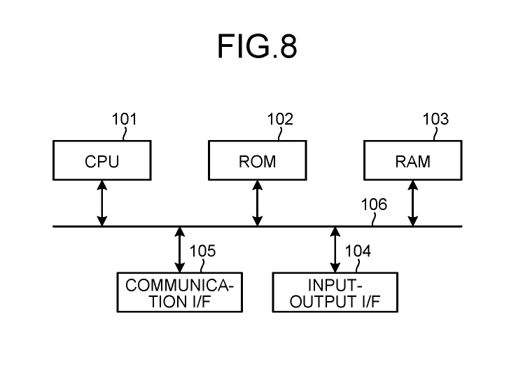

The mixer-type recommendation engine 10 (the first recommendation engine 11, the second recommendation engine 12, and the mixer 13), the interest level calculator 30, and the ratio control unit 40 that are implemented in a server device can be implemented using hardware or using software running in cooperation with hardware. In the case of using software, for example, as illustrated in FIG. 8, the server device can have the hardware configuration of a general-purpose computer including a processor such as a central processing unit (CPU) 101, memory devices such as a read only memory (ROM) 102 and a random access memory (RAM) 103, an input-output I/F 104 to which a display panel and various operation devices are connected, a communication I/F 105 that establishes connection with a network and performs communication, and a bus 106 that connects the other constituent elements to each other.

Meanwhile, a computer program that is executed in the server device having the abovementioned hardware configuration is, for example, recorded as an installable file or an executable file in a computer-readable recording medium such as a compact disk read only memory (CD-ROM), a flexible disk (FD), a compact disk recordable (CD-R), or a digital versatile disc (DVD); and is provided as a computer program product. Alternatively, the computer program executed in the server device can be stored in a downloadable manner in a computer connected to a network such as the Internet. Still alternatively, the computer program executed in the server device can be distributed via a network such as the Internet. Still alternatively, the computer program executed in the server device can be stored in advance in the ROM 102.

The computer program executed in the server device contains modules of the mixer-type recommendation engine 10 (the first recommendation engine 11, the second recommendation engine 12, and the mixer 13), the interest level calculator 30, and the ratio control unit 40. As far as the actual hardware is concerned, for example, the CPU 101 (the processor) reads the computer program from the recording medium and executes it, so that the abovementioned constituent elements are loaded and generated in the RAM 103 (a main memory). Meanwhile, some or all of the abovementioned constituent elements can be implemented using dedicated hardware such as an application specific integrated circuit (ASIC) or a field-programmable gate array (FPGA).

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. An item recommendation system comprising:
a first recommendation engine that selects, from a group of items, first recommended items predicted to match with preference of a user;
a second recommendation engine that selects, from the group of items, second recommended items which do not match with preference of the user but are expected to be of interest to the user;
a mixer that mixes the first recommended items and the second recommended items, and forms a group of recommended items to be presented to the user;
a user interface that presents the group of recommended items to the user in an operable manner;
a calculator that, based on a user operation with respect to the group of recommended items, calculates a level of interest indicating degree of satisfaction of the user with respect to the group of recommended items; and
a ratio control unit that, based on the level of interest, varies a mixing ratio of the first recommended items and the second recommended items in the group of recommended items formed by the mixer.

2. The system according to claim 1, wherein the second recommendation engine selects, as the second recommendation items from among the items included in the group of items, items in descending order of a serendipity index value that is calculated using a product of a first value, which indicates probability at which the user takes interest, and a second value, which indicates degree of deviation from preference of the user.

3. The system according to claim 2, wherein the serendipity index value is calculated using linear sum of the product of the first value and the second value with a third value indicating probability at which an unspecified user takes interest.

4. An item recommendation method implemented in an item recommendation system, comprising:
selecting, from a group of items, first recommended items predicted to match with preference of a user;
selecting, from the group of items, second recommended items which do not match with preference of the user but are expected to be of interest to the user;
mixing that includes mixing the first recommended items and the second recommended items, and forming a group of recommended items to be presented to the user;
presenting the group of recommended items to the user in an operable manner;
calculating, based on a user operation with respect to the group of recommended items, a level of interest indicating degree of satisfaction of the user with respect to the group of recommended items; and
varying, based on the level of interest, a mixing ratio of the first recommended items and the second recommended items in the group of recommended items.

5. A computer program product comprising a computer readable medium including programmed instructions, wherein the instructions, when executed by a computer, cause the computer to perform:
a function of selecting, from a group of items, first recommended items predicted to match with preference of a user;
a function of selecting, from the group of items, second recommended items which do not match with preference of the user but are expected to be of interest to the user;
a function of mixing that includes mixing the first recommended items and the second recommended items, and forming a group of recommended items to be presented to the user;
a function of presenting the group of recommended items to the user in an operable manner;
a function of calculating, based on a user operation with respect to the group of recommended items, a level of interest indicating degree of satisfaction of the user with respect to the group of recommended items; and
a function of varying, based on the level of interest, a mixing ratio of the first recommended items and the second recommended items in the group of recommended items.
